(19) United States
(12) Patent Application Publication
(10) Pub. No.: US 2015/0187051 A1
(43) Pub. Date: Jul. 2, 2015

(54) METHOD AND APPARATUS FOR ESTIMATING IMAGE NOISE

(71) Applicant: Shih-Ta Wu, Kaohsiung City (TW)

(72) Inventor: Shih-Ta Wu, Kaohsiung City (TW)

(73) Assignee: FARADAY TECHNOLOGY CORP., Hsinchu (TW)

(21) Appl. No.: 14/242,875

(22) Filed: Apr. 2, 2014

(30) Foreign Application Priority Data
Dec. 31, 2013 (TW) 102149149

(51) Int. Cl. G06T 5/00

(52) U.S. Cl. CPC G06T 5/001; G06T 2207/10004; G06T 2207/10024

(57) ABSTRACT

In a method for estimating image noise, plural sample blocks of an image are determined; a mean of at least one color component of each of the sample blocks and a standard deviation of at least one color component of each of the sample blocks are calculated; the sample blocks are distributed into plural segments according to the means of the sample blocks; a weighted average of the standard deviations of all of the sample blocks of each of the segments is calculated according to at least one threshold value that is determined according to the minimum standard deviation among the standard deviations of all of the sample blocks of the segment. The weighted average may be applied to noise reduction, edge detection, or motion detection of the image.

### CROSS-REFERENCE TO RELATED APPLICATION

This application claims the priority benefit of Taiwan application serial no. 102149149, filed on Dec. 31, 2013. The entirety of the above-mentioned patent application is hereby incorporated by reference herein and made a part of this specification.

### TECHNICAL FIELD

The technical field relates to a method and an apparatus for image processing, more particularly, to a method and an apparatus for estimating image noise.

### BACKGROUND

When ambient light is insufficient, images captured by electronic image capturing apparatuses, such as digital cameras and digital camcorders, are very much likely to encounter the issue of image noise. To resolve said issue, the noise level must be estimated at first.

In a conventional noise estimation method, a calibration process is performed in advance; that is, the noise levels corresponding to various light sources and various sensor gain are measured to create a lookup table in advance. The lookup table provides the reference to the noise levels of the images, so as to eliminate the noise. However, the calibration process in advance is complicated; in addition, if the parameters related to the front-stage processing circuit are changed, recalibration is required to rebuild the lookup table.

Therefore, the calibration process is not performed in advance according to the common noise estimation; instead, the noise level of the images is estimated in real time. To perform such real-time estimation, how to exclude the non-planar regions in the images should be taken into consideration. In the images, the so-called planar regions refer to the regions that are monotonous and lack of changes, such as a desktop or a wall. The non-planar regions are rather complex and delicate, such as the edge of an object, the complex structure of the object, or complex textures.

In order to perform said real-time estimation, the signal-dependent characteristics of noise should also be taken into account; i.e., the noise level of the image may vary together with the pixel intensity in the image, so as to prevent excessive blur or insufficient filter strength in some regions in the image due to the constant noise level.

### SUMMARY

One of exemplary embodiments provides a method and an apparatus for estimating image noise, so as to solve the above problems occurring during the real-time estimation.

In an exemplary embodiment of the disclosed example, a method for estimating image noise comprises: determining a plurality of sample blocks of an image; calculating the mean of at least one color component of each of the sample blocks and the standard deviation of at least one color component of each of the sample blocks; distributing the sample blocks into a plurality segments based on the mean; calculating a weighted average of the standard deviations of all of the sample blocks of each of the segments according to at least one threshold value. The at least one threshold value is determined according to the minimum standard deviation among the standard deviations of all of the sample blocks of each of the segments. The weighted average is applied for noise reduction, edge detection, or motion detection of the image.

In an exemplary embodiment of the disclosed example, an apparatus for estimating image noise includes a memory for storing an image and a processor. The processor coupled to the memory executes said method for estimating image noise.

In view of the above, in the method and the apparatus for estimating image noise as provided in an exemplary embodiment of the disclosed example, the non-planar regions in the image are excluded according to the threshold value, the sample blocks are distributed into a plurality of segments according to the pixel intensity, and the noise level of each segment (i.e., said weighted average) is provided to avoid excessive blur or insufficient filter strength in some regions in the image due to the constant noise level.

In order to make the aforementioned and other features and advantages of the disclosed example understandable, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating an apparatus for estimating image noise according to an exemplary embodiment of the disclosed example.

FIG. 2 is a flow chart illustrating a method for estimating image noise according to an exemplary embodiment of the disclosed example.

FIG. 3 is a schematic diagram illustrating sample blocks in an image according to an exemplary embodiment of the disclosed example.

FIG. 4 is a schematic diagram illustrating sample blocks in an image according to another exemplary embodiment of the disclosed example.

FIG. 5A, FIG. 5B, and FIG. 5C are schematic diagrams illustrating the statistics of sample blocks in an image according to an exemplary embodiment of the disclosed example.

FIG. 6A, FIG. 6B, and FIG. 6C are schematic diagrams illustrating the statistics of sample blocks in an image according to another exemplary embodiment of the disclosed example.

FIG. 7 is a schematic diagram illustrating the statistics of sample blocks in an image before the statistics are filtered by threshold values according to another exemplary embodiment of the disclosed example.

FIG. 8 is a schematic diagram illustrating the statistics of sample blocks in image after the statistics are filtered by threshold values according to another exemplary embodiment of the disclosed example.

FIG. 9 is a schematic diagram illustrating the noise level of each segment according to an exemplary embodiment of the disclosed example.

### DETAILED DESCRIPTION OF DISCLOSED EMBODIMENTS

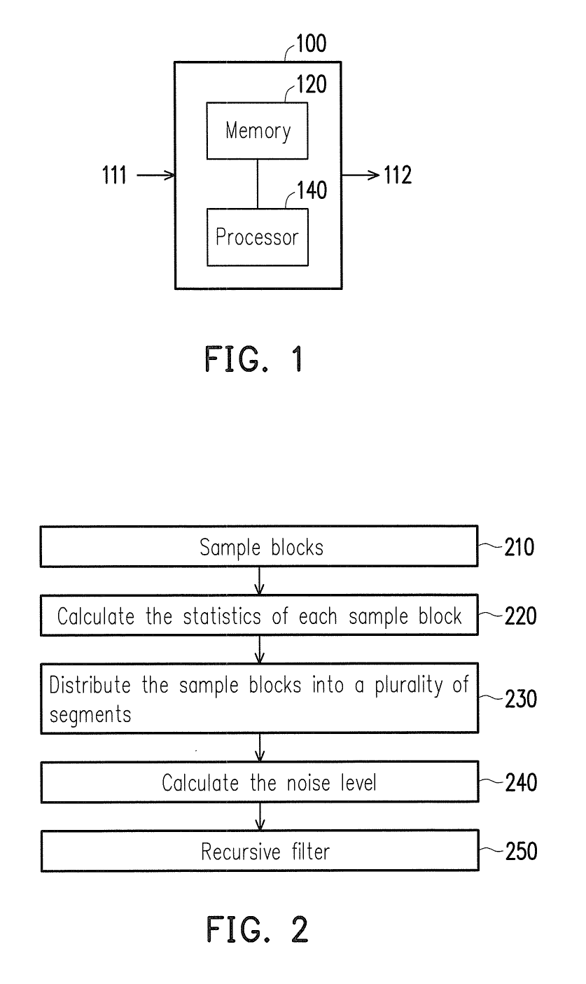

FIG. 1 is a schematic diagram illustrating an apparatus 100 for estimating image noise according to an exemplary embodiment of the disclosed example. The apparatus 100 for estimating image noise may receive an image 111 and output a noise profile 112 of the image 111. The noise profile 112 may be provided to the subsequent image processing units. The noise profile 112 may be applied for noise reduction, edge detection, or motion detection of the image 111.

The apparatus 100 for estimating image noise includes a memory 120 and a processor 140. The processor 140 is coupled to the memory 120. With reference to FIG. 2, the processor 140 may execute the method for estimating image noise to generate the noise profile 112. The image 111 may be stored in the memory 120. In addition, as shown in FIG. 2, information and data related to the estimation of image noise may be also stored in the memory 120.

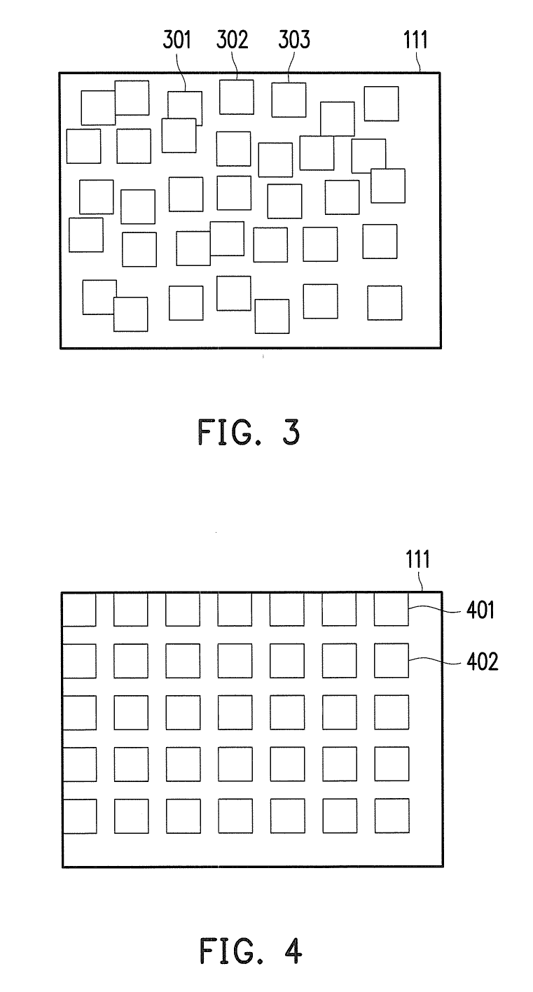

FIG. 2 is a flow chart illustrating a method for estimating image noise according to an exemplary embodiment of the disclosed example, and the method may be performed by the processor 140. First, with reference to FIG. 3 and FIG. 4, sample blocks of the image 111 are determined in step 210. FIG. 3 shows the sample blocks (e.g., the sample blocks 301, 302 and 303) in the image 111 according to an exemplary embodiment of the disclosed example. The sample blocks in FIG. 3 are randomly located, and some of the sample blocks are overlapped. FIG. 4 shows a plurality of sample blocks (e.g., the sample blocks 401 and 402) in the image 111 according to another exemplary embodiment of the disclosed example. The sample blocks in FIG. 4 are located according to the number of sample blocks. The sample blocks are equally spaced in the image, so the sample blocks are orderly arranged and not overlapped. As shown in FIG. 3 and FIG. 4, the size of each sample block is 8×8 pixels. In other exemplary embodiments, the size of each sample block is allowed to be adjusted by the users.

The statistics of each sample block are calculated in step 220. The said statistics include the mean and the standard deviation of at least one color component of each said sample block.

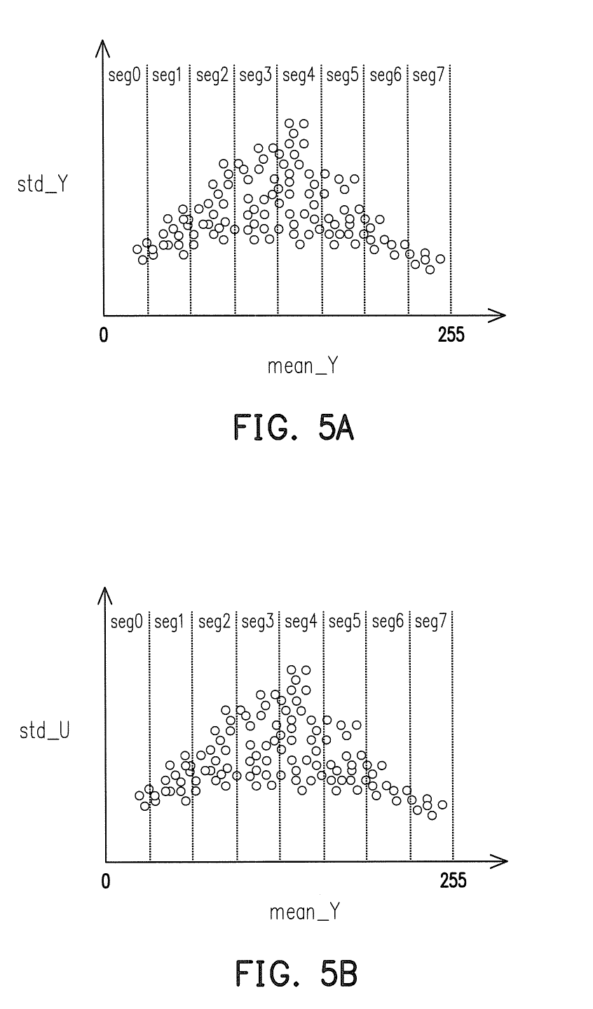

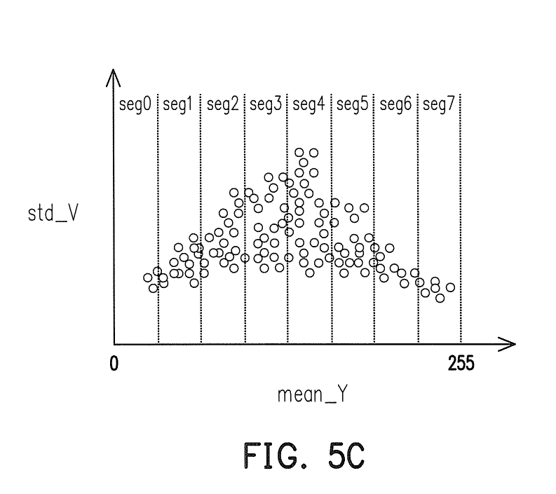

For example, if the image 111 is in a YUV color format, each pixel of the image 111 has three color components Y, U, and V. The three color components in each sample block may be calculated to obtain four statistics, i.e., mean_Y, std_Y, std_U, and std_V. Here, the mean_Y is the mean of the Y components of all pixels of the sample block, std_Y is the standard deviation of the Y components of all the pixels of the sample block, std_U is the standard deviation of the U components of all the pixels of the sample block, and std_V is the standard deviation of the V components of all the pixels of the sample block. In the present exemplary embodiment, the value of each color component in each pixel is, for instance, 8 bits, i.e., within the range from 0 to 255. However, the value of each color component in the disclosed example is not limited to 8 bits. The above statistics are shown in FIG. 5A, FIG. 5B, and FIG. 5C. The horizontal axis in FIG. 5A represents the mean_Y, and the vertical axis in FIG. 5A represents the std_Y. Each point in FIG. 5A corresponds to one sample block, and the coordinates of each point in FIG. 5A are the mean_Y and the std_Y of the sample block. Similarly, the horizontal axis in FIG. 5B represents the mean_Y, and the vertical axis in FIG. 5B represents the std_U. The horizontal axis in FIG. 5C represents the mean_Y, and the vertical axis in FIG. 5C represents the std_V.

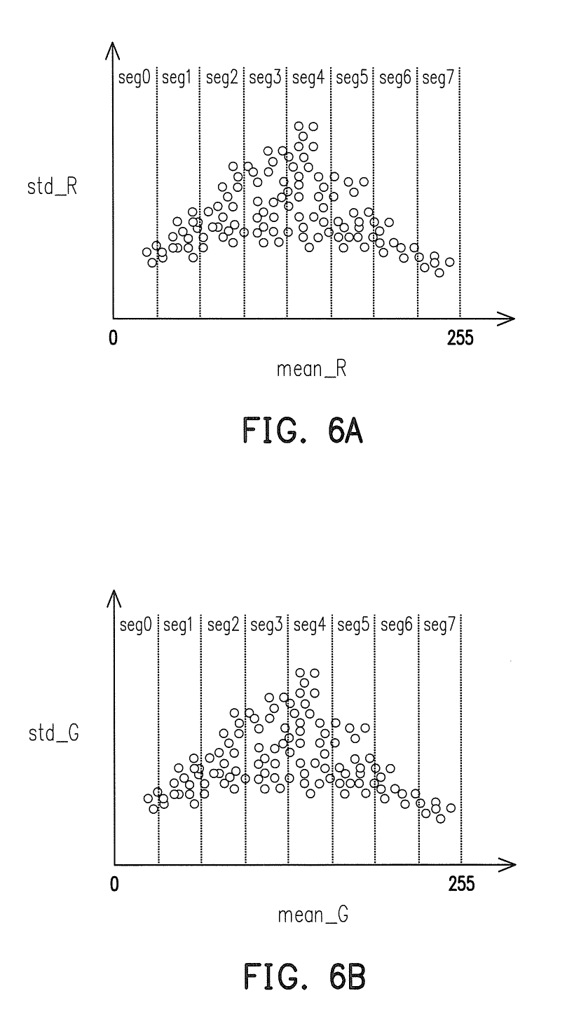

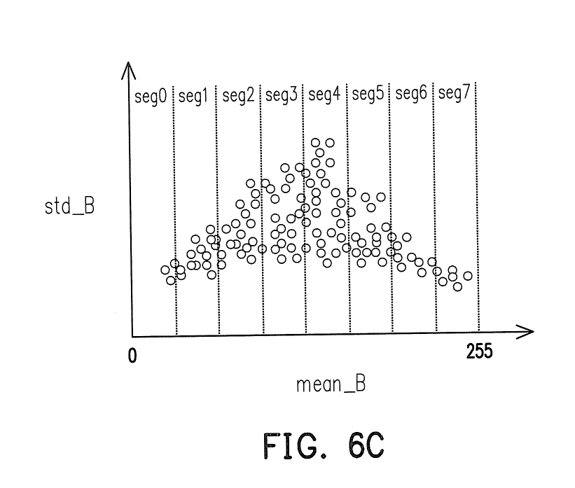

In another embodiment, if the image 111 is in the RGB color format, each pixel of the image 111 has three color components R, G, and B. The three color components in each sample block may be calculated to obtain six statistics, i.e., mean_R, mean_G, mean_B, std_R, std_G, and std_B. Here, the mean_R is the mean of the R components of all pixels of the sample block, and std_R is the standard deviation of the R components of all the pixels of the sample block. The other four statistics, i.e., the mean_G, the mean_B, the std_G, and the std_B may be deduced from the above, respectively, and the above statistics are shown in FIG. 6A, FIG. 6B, and FIG. 6C. The horizontal axis in FIG. 6A represents the mean_R, and the vertical axis in FIG. 6A represents the std_R. Each point in FIG. 6A corresponds to one sample block, and the coordinates of each point in FIG. 6A are mean_R and std_R of the sample block. Similarly, the horizontal axis in FIG. 6B represents the mean_G, and the vertical axis in FIG. 6B represents the std_G. The horizontal axis in FIG. 6C represents the mean_B, and the vertical axis in FIG. 6C represents the std_B.

In step 230, the sample blocks are distributed into a plurality of segments according to the means of said sample blocks. As exemplarily shown in FIG. 5A, the range of mean_Y of all sample blocks is divided into eight segments seg0 to seg7, and each sample block is distributed into the segment where the mean_Y of that sample block exists. The way to divide the range of the mean into segments shown in FIGS. 5B and 5C and the way to divide the range of the mean into the segments seg0 to seg7 shown in FIG. 6A to FIG. 6C are identical or similar to that described above. The above eight segments seg0 to seg7 are exemplary, and the number of segments should not be construed as a limitation to the disclosed example. The segments seg0 to seg7 in FIG. 5A to FIG. 5C and FIG. 6A to FIG. 6C are divided equally, while the segments seg0 to seg7 may not be equally divided in another exemplary embodiment.

In step 240, the noise level of the image 111 is calculated. Step 240 may be performed once in each segment for each color component in the image 111 to calculate the noise level of each segment for each color component of the image 111. For example, if the image 111 is in the YUV color format, FIG. 5A to FIG. 5C respectively show three color components of the image 111 corresponding to the three color components of Y, U, and V, and the step 240 may be executed to calculate the noise level of each segment seg0 to seg7 shown in FIG. 5A to FIG. 5C, i.e., 24 segments seg0 to seg7 in total. If the image 111 is in the RGB color format, FIG. 6A to FIG. 6C respectively show three color components of the image 111 corresponding to the three color components of R, G, and B, and the step 240 may be executed to calculate the noise level of each segment seg0 to seg7 shown in FIG. 6A to FIG. 6C, i.e., 24 segments seg0 to seg7 in total. The segment seg0 in FIG. 6 is taken as an example for demonstrating the step 240, and the other segments of each color component may be deduced from said demonstration and thus will not be further explained hereinafter

In step 240, the noise level noise_cur of the segment seg0 is calculated by the following equation.

$$noise\_cur = \frac{{\sum }_{i = 1}^{N} w ( i ) \times std ( i )}{{\sum }_{i = 1}^{N} w ( i )} \qquad ( 1 )$$

The noise level noise_cur is a weighted average, wherein N is the number of sample blocks in the segment seg0, std(i) is the standard deviation std_R of the i-th sample block in the segment seg0, and w(i) is the weight corresponding to the i-th sample block in the segment seg0. The weight w(i) is determined by comparing the standard deviation std(i) and at least one threshold value. For instance, a threshold value std_Th is calculated by the following equation (2) at first.

std_{—}Th=k×std_Min (2)

In the equation (2), k is the default parameter, and k≧1; std_Min is the minimum standard deviation among the standard deviations std_R of all of the sample blocks in the segment seg0. Therefore, the sample block having the standard deviation std_Min may represent the planar region in the image 111. The standard deviation std_Min and the threshold value std_Th are proportional to each other according to the equation (2). If std(i)≦std_Th, set w(i)=1. If std(i)>std_Th, set w(i)=0. If the standard deviation std(i) of a certain sample block is greater than the threshold value std_Th, the sample block is a non-planar region, and the weight of such sample block is zero.

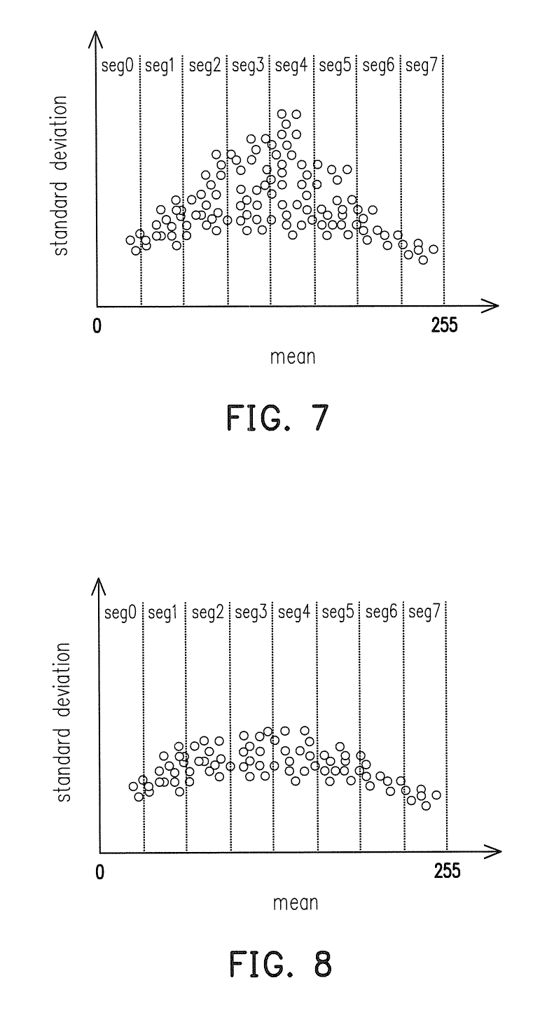

Therefore, the threshold value std_Th may be used to exclude non-planar regions in the image, so as not to affect the noise estimation. FIG. 7 is a schematic diagram illustrating the statistics of the sample blocks before the statistics are filtered by the threshold value std_Th according to an exemplary embodiment of the disclosed example. FIG. 7 may be one of FIG. 5A to FIG. 5C and FIG. 6A to FIG. 6C. FIG. 8 corresponding to FIG. 7 is a schematic diagram illustrating the statistics of the sample blocks after the statistics are filtered by the threshold value std_Th.

The above description is an example for determining the weight w(i) based on the standard deviation std(i) and a threshold value std_Th. The following example for determining the weight w(i) is based on the standard deviation std(i) and the two threshold values std_Th and std_Th2. First, the threshold values std_Th1 and std_Th2 are calculated by the following equations (3) and (4).

std_{—}Th1=k1×std_Min (3)

std_{—}Th2=k2×std_Min (4)

k1 and k2 are the default parameters of the equations (3) and (4), where k1≧1, k2≧1 and k1<k2. If std(i)≦std_Th1, set w(i)=w1; if std_Th1<std(i)≦std_Th2, set w(i)=w2; if std(i)>std_Th2, set w(i)=0. Note that w1 and w2 are also the default parameters, where 0≦w1≦1, 0≦w2≦1, and w1≧w2.

The number of the threshold values of the weight is not limited in the disclosed example; in another embodiment three or more threshold values may be applied, and how to determine the weight w(i) may be deduced from the above.

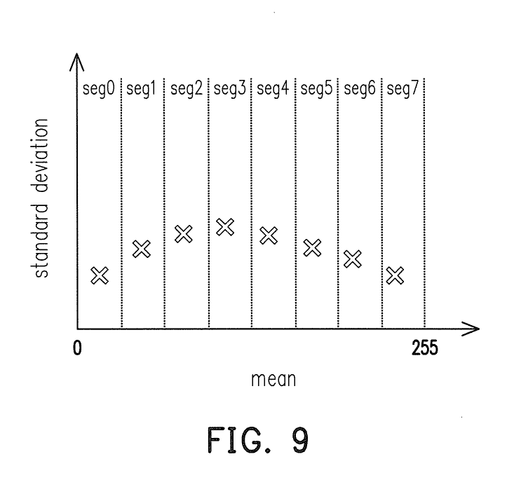

In step 240, the noise level noise_cur in each segment for each color component in the image 111 is calculated by equation (1). For instance, FIG. 9 is a schematic diagram illustrating the noise levels in the segments seg0 to seg7 according to an exemplary embodiment of the disclosed example, wherein X in each segment is the noise level noise_cur of the segment.

According to the exemplary embodiment shown in FIG. 9, the number of the sample blocks in each segment seg0 to seg7 is large enough (the number of the sample blocks is greater than a preset threshold value). Therefore, the weighted average in each segment seg0 to seg7 may be calculated by equation (1), and the calculated weighted average may serve as of the noise level noise_cur of each segment seg0 to seg7. However, in other embodiments, the number of the sample blocks in some segments may be small (the number of the sample blocks is lesser than or equal to the preset threshold value). The minimum standard deviations std_Min obtained in such segments may be standard deviations of non-planar regions. Therefore, the equation (1) may not be applicable to those segments. In this case, the noise level noise_cur of a segment whose number of sample blocks is lesser than or equal to the preset threshold value may be calculated by interpolation or extrapolation according to the noise level noise_cur of the closest segment whose number of sample blocks is greater than the threshold value.

For example, if the number of the sample blocks in the first segment seg0 is lesser than or equal to the threshold value, a default scale ratio of the noise level noise_cur of the segment which is closest to the first segment seg0 and whose number of sample blocks is greater than the threshold value may be set as the noise level noise_cur of the first segment seg0. Said default scale ratio may be 40%, 50%, 60%, or another ratio. If the number of the sample block in the last segment seg7 is lesser than or equal to the threshold value, the above principle may be applied. If the number of the sample blocks in a middle segment (i.e., any one of the segments seg1 to seg6) is lesser than or equal to the threshold value, the noise levels noise_cur of the two closest segments at both sides of the middle segment whose numbers of sample blocks are greater than the threshold value may be interpolated, so as to obtain the noise level noise_cur of the middle segment.

In an exemplary embodiment of the disclosed example, the apparatus 100 for estimating image noise may omit the step 250 and output the combination of the noise level noise_cur of each color component in each segment in the image 111. The combination is the noise profile 112 of the image 111. If the image 111 is in the YUV color format, the noise profile 112 is the combination of the noise levels noise_cur in 24 segments seg0 to seg7 shown in FIG. 5A to FIG. 5C. If the image 111 is in the RGB color format, the noise profile 112 is the combination of the noise levels noise_cur in 24 segments seg0 to seg7 shown in FIG. 6A to FIG. 6C.

In another embodiment, the image 111 is a frame in a video clip, and the noise level is updated by a recursive filter through further performing the step 250. By means of the following equation (5) and equation (6), the recursive average noise(t) acting as a new noise level for each segment is updated by calculating noise(t−1) and noise_cur(t) in each segment. Similar to step 240, step 250 may be executed once respectively for each color component in each segment in the image 111.

noise(t)=(1−k3)×noise(t−1)+k3×noise_{—}cur(t) (5)

noise(0)=noise_{—}cur(0) (6)

Here, k3 is the default parameter, and 0≦k3≦1; t is the corresponding time of the image 111 in said video clip and may also represent the frame number of the image 111 in the said video clip, and t is a positive integer; noise_cur(t) is the weighted average noise_cur calculated by the equation (1) according to the image 111, noise_cur(t−1) is the weighted average noise_cur calculated by the equation (1) according to the previous image of the image 111, and the rest may be deduced therefrom. Therefore, noise(t−1) is the noise level at the time before the image 111 in said video clip, and noise(t) is the noise level at the time of the image 111 in said video clip.

If step 250 is executed, the apparatus 100 for estimating image noise may output the combination of the recursive average noise(t) of each color component in each segment in the image 111, and the combination serves as the noise profile 112 of the image 111.

The above default parameters, e.g., k, k1, k2, k3, w1, w2, etc., are allowed to be adjusted by the users.

To sum up, the noise estimation only requires one single image according to an exemplary embodiment of the disclosed example. The statistics of color components may be distributed into a plurality of segments for calculating the noise levels of the segments, thereby avoiding excessive blur or insufficient filter strength in some regions in the image due to the constant noise level. The non-planar regions in the image are excluded by calculations of the threshold value and the weighted average, and thus edge detection is not required for detecting the planar regions in the image. In addition, the recursive filter may be applied to obtain the estimated noise level stably and reduce the estimation errors in an exemplary embodiment of the disclosed example. It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for estimating image noise, the method comprising:
determining a plurality of sample blocks of an image;
calculating a mean of at least one color component of each of the sample blocks and a standard deviation of the at least one color component of each of the sample blocks;
distributing the sample blocks into a plurality of segments based on the mean; and
calculating a weighted average of the standard deviations of all of the sample blocks of each of the segments according to at least one threshold value, wherein the at least one threshold value is determined according to a minimum standard deviation among the standard deviations of all of the sample blocks of the each of the segments, and the weighted average is applied for noise reduction, edge detection, or motion detection of the image.

2. The method for estimating image noise of claim 1, wherein the step of distributing the sample blocks into the segments comprises:
dividing a numerical range of the means of the sample blocks into the segments; and
distributing each of the sample blocks into one of the segments where the mean of the each of the sample blocks exists.

3. The method for estimating image noise of claim 1, wherein a weight of each of the sample blocks is determined by comparing the standard deviation of the each of the sample blocks and the at least one threshold value when the weighted average is calculated.

4. The method for estimating image noise of claim 3, wherein the weight corresponding to one of the sample blocks when the standard deviation of the one sample block is lower than one said threshold value is greater than the weight corresponding to the one sample block when the standard deviation of the one sample blocks is greater than the one said threshold value.

5. The method for estimating image noise of claim 3, wherein the weight of one of the sample blocks is zero if the standard deviation of the one of the sample blocks is greater than one of the at least one threshold value.

6. The method for estimating image noise of claim 1, wherein each of the at least one threshold value in each of the segments is proportional to the minimum standard deviation among the standard deviations of all of the sample blocks in the each of the segments.

7. The method for estimating image noise of claim 1 further comprising:
in each of the segments, if the number of the sample blocks in the segment is greater than a threshold value, setting the weighted average in the segment as a noise level of the segment; and
if the number of the sample blocks in the segment is lesser than or equal to the threshold value, calculating the noise level of the segment by interpolation or extrapolation according to the noise level of at least another one of the segments, wherein the another segment is the one segment closest to the segment which has the number of the sample blocks lesser than or equal to the threshold value among the segments which have numbers of sample blocks that are greater than the threshold value.

8. The method for estimating image noise of claim 1, wherein the image is a frame in a video clip, and the method for estimating image noise further comprises:
in each of the segments, calculating a recursive average of the image according to the weighted average of the image and a previous recursive average of the video clip and setting the recursive average of the image as the noise level of the each of the segments.

9. An apparatus for estimating image noise, the apparatus comprising:
a memory storing an image; and
a processor coupled to the memory, the processor determining a plurality of sample blocks of the image, calculating a mean and a standard deviation of at least one color component of each of the sample blocks, distributing the sample blocks into a plurality of segments according to the mean, and calculating a weighted average of the standard deviations of all of the sample blocks of each of the segments according to at least one threshold value, wherein the at least one threshold value is determined according to a minimum standard deviation among the standard deviations of all of the sample blocks of the each of the segments, and the weighted average is applied for noise reduction, edge detection, or motion detection of the image.

10. The apparatus for estimating image noise of claim 9, wherein the processor divides a numerical range of the means the sample blocks into the segments and distributes each of the sample blocks into one of the segments where the mean of the each of the sample blocks exists.

11. The apparatus for estimating image noise of claim 9, wherein a weight of each of the sample blocks is determined by comparing the standard deviation of the each of the sample blocks and the at least one threshold value when the weighted average is calculated.

12. The apparatus for estimating image noise of claim 11, wherein the weight corresponding to one of the sample blocks when the standard deviation of the one sample blocks is lower than one said threshold value is greater than the weight corresponding to the one sample block when the standard deviation of the one sample blocks is greater than the one said threshold value.

13. The apparatus for estimating image noise of claim 11, wherein the weight of one of the sample blocks is zero if the standard deviation of the one of the sample blocks is greater than one of the at least one threshold value.

14. The apparatus for estimating image noise of claim 9, wherein each of the at least one threshold value in each of the segments is proportional to the minimum standard deviation among the standard deviations of all of the sample blocks in the each of the segments.

15. The apparatus for estimating image noise of claim 9, wherein in each of the segments, if the number of the sample blocks in the segment is greater than a threshold value, the processor sets the weighted average in the segment as the noise level of the segment; and
if the number of the sample blocks in the segment is lesser than or equal to the threshold value, the processor calculates the noise level of the segment by interpolation or extrapolation according to the noise level of at least another one of the segments, wherein the another segment is the one segment closest to the segment which has the number of the sample blocks lesser than or equal to the threshold value among the segments which have numbers of sample blocks that are greater than the threshold value.

16. The apparatus for estimating image noise of claim 9, wherein the image is a frame in a video Clip, and the processor in each of the segments calculates a recursive average of the image according to the weighted average and a previous recursive average of the video clip and sets the recursive average of the image as the noise level of the each of the segments.
